(19) United States
(12) Patent Application Publication
(10) Pub. No.: US 2014/0013162 A1
(43) Pub. Date: Jan. 9, 2014

(54) INFORMATION PROCESSING APPARATUS, TRANSMITTING DEVICE AND CONTROL METHOD OF INFORMATION PROCESSING APPARATUS

(71) Applicant: FUJITSU LIMITED, Kawasaki (JP)

(72) Inventor: Masahiro MISHIMA, Kawasaki (JP)

(73) Assignee: FUJITSU LIMITED, Kawasaki (JP)

(21) Appl. No.: 14/022,555

(22) Filed: Sep. 10, 2013

Related U.S. Application Data
(63) Continuation of application No. PCT/JP2011/057253, filed on Mar. 24, 2011.

(51) Int. Cl. G06F 11/263

(52) U.S. Cl. CPC G06F 11/263
USPC 714/33

(57) ABSTRACT

A transmission device has a first input unit that inputs data, a second input unit that inputs data, a first information processing unit that outputs data resulting from information processing of data input by the first input unit or data input by the second input unit, a first holding unit that holds data output by the first information processing unit, a second holding unit that holds data output by the first information processing unit, a control information holding unit that holds control information, a first selection unit that selects, on the basis of the control information, either the data held by the first holding unit or the data held by the second holding unit, and a first output unit that returns data selected by the first selection unit to the first input unit, on the basis of the control information.

### CROSS-REFERENCE TO RELATED APPLICATION

This application is a continuation application of International Application PCT/JP2011/057253, filed on Mar. 24, 2011, and designated the U.S., the entire contents of which are incorporated herein by reference.

### FIELD

The present invention relates to an information processing apparatus, a transmitting device and a control method of the information processing apparatus.

### BACKGROUND

Some of information processing apparatuses are shipped as products in a way that changes, in response to a variety of needs, system architectures specified by types and the number of CPUs (Central Processing Units) serving as arithmetic processing devices to be mounted or specified by types and the numbers of boards, etc. It is desired of tests of the information processing apparatuses having such a multiplicity of system architectures, e.g., a test for shipping the product or a mass-production test to check the operation after activating circuits included in the system architecture in order to detect defects of components, e.g., a defect of a chip of the CPU etc or a defect of the board.

FIGS. 1 through 3 illustrate the system architecture of the information processing apparatus. The information processing apparatus depicted in FIGS. 1 through 3 is given by way of an example of the product enabling the system architecture to be changed by an extension of the CPU or an extension of the board. In FIG. 1, two CPUs, i.e., CPU00 and CPU01, are mounted on the board (board0). The CPU00 and the CPU01 have, e.g., a plurality of interfaces and are connected to each other.

In FIG. 2, four CPUs, i.e., CPU00 through CPU03, are mounted on the board (board0). Each of the CPU00 through the CPU03 has, e.g., the plurality of interfaces and is connected to other CPUs.

The information processing apparatus in FIG. 3 has a plurality of boards (board0, board1). The four CPUs, i.e., the CPU00 through the CPU03, are mounted on the board (board0). Each of the CPU00 through the CPU03 has, e.g., the plurality of interfaces and is connected to other CPUs. Further, the four CPUs, i.e., CPU10 through the CPU13, are mounted also on the board (board1). Each of the CPU10 through the CPU13 has, e.g., the plurality of interfaces and is connected to other CPUs. Moreover, the CPU00 through the CPU03 on the board (board0) and the CPU10 through the CPU13 on the board (board1) are mutually connected via crossbar switches (XB0, XB1). For example, the crossbar switch (XB0) switches over the connection between a combination of the CPU00 and the CPU02 and a combination of the CPU10 and the CPU12, thus transferring the data. Moreover, the crossbar switch (XB1) switches over the connection between a combination of the CPU01 and the CPU03 and a combination of the CPU11 and the CPU13, thus transferring the data.

Accordingly, in the example of FIG. 3, eight pieces of CPUs can be connected to each other. The information processing apparatuses in FIGS. 1 and 2 have a partial configuration of the information processing apparatus in FIG. 3. For example, it is herein assumed that the configuration in FIG. 3 is a maximum configuration.

In the case of testing each of the information processing apparatuses having the system architectures as in FIGS. 1 through 3, it is desired that the operation of the information processing apparatus is checked after activating circuits of interfaces included in the respective CPUs. By the way, as in FIGS. 1 and 2, the information processing apparatuses not having the maximum configuration include unused circuits as the case may be. For instance, if the information processing apparatus in FIG. 1 can take the configuration in FIG. 2, the CPU00 or the CPU01 in the configuration of FIG. 1 includes an unused interface for communications with the CPU02, the CPU03, etc. Further, e.g., in the configuration of FIG. 2, the CPU00 through the CPU03 have the unused interfaces for the communications with the respective crossbar switches (XB0, XB1).

Even if the configuration of the information processing apparatus when shipped is not the maximum configuration, such a case exists that the CPU or the board is extended after being shipped. For example, the case is such that the information processing apparatus in FIG. 1 is expanded as in FIG. 2. Further, another case is that the information processing apparatuses in FIGS. 1 and 2 are expanded as in FIG. 3. As a result of the extension, the interface circuit not used so far before the extension gets used. In this case, with a start of using the interface circuit remaining unused so far, such a possibility arises that a defect in the information processing apparatus gets revealed.

In the mass-production test, generally the test is implemented in a state of being approximate to the maximum configuration to the greatest possible degree in order to reduce the defects when extended. In the case of detecting the defect in the mass-production test with the maximum configuration, however, there increase a labor and a cost for an analysis, a repair, etc. It is therefore desired to detect as many defects as possible by inspecting the component such as the CPU in a state of being as close to a single component unit as possible. The inspection in this case entails performing the check efficiently within a short period of time, and hence it is desired to implement the inspection with the simple configuration to the greatest possible degree. On the other hand, even in the inspection of the information processing apparatus with the simple configuration to the greatest possible degree, it is desired that the operation can be checked in a state of being closely equal to the information processing apparatus with a complicated configuration after being extended.

### DOCUMENTS OF PRIOR ARTS

### Patent Documents

[Patent document 1] Japanese Laid-open Patent Publication No. 2002-222921
[Patent document 2] Japanese Laid-open Patent Publication No. 10-132902
[Patent document 3] Japanese Laid-open Patent Publication No. 09-128349

### SUMMARY

One aspect of the technology of the disclosure can be exemplified as a transmitting device connected to a first receiving device possessed by an information processing apparatus.

This transmitting device includes a first input unit to input data, a second input unit to input data and a first information processing unit to output data based on information processing of the data input by the first input unit or the data input by the second input unit. The transmitting device further includes a first retaining unit to retain the data output by the first information processing unit, a second retaining unit to retain the data output by the first information processing unit and a control information retaining unit to retain control information. The transmitting device still further includes a first selection unit to select, based on the control information retained in the control information retaining unit, any one of the data retained in the first retaining unit and the data retained in the second retaining unit, and a first output unit to turn the data selected by the first selection unit back to the first input unit on the basis of the control information retained in the control information retaining unit.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating a system architecture of an information processing apparatus;

FIG. 2 is a diagram illustrating the system architecture of the information processing apparatus;

FIG. 3 is a diagram illustrating the system architecture of the information processing apparatus;

FIG. 4 is a diagram illustrating a configuration of the information processing apparatus according to a first working example;

FIG. 5 is a diagram illustrating details of a data transfer unit;

FIG. 6 is a diagram illustrating a configuration for invalidating a signal;

FIG. 7 is a diagram illustrating a configuration of the information processing apparatus according to a second working example;

FIG. 8 is a diagram illustrating an in-depth configuration of a router within a CPU together with peripheral circuits;

FIG. 9 is a diagram illustrating a logical connecting relation corresponding to setting of TEST_MODE[0:3];

FIG. 10 is a diagram illustrating a processing sequence of a transmitting control unit;

FIG. 11 is a diagram illustrating a processing sequence of a receiving control unit;

FIG. 12 is a diagram illustrating bus selection logic of a bus selector;

FIG. 13 is a diagram illustrating the bus selection logic of the bus selector;

FIG. 14 is a diagram illustrating the bus selection logic of the bus selector;

FIG. 15 is a diagram illustrating the bus selection logic of the bus selector; and

FIG. 16 is a diagram illustrating a time chart when transmitting a packet.

### DESCRIPTION OF EMBODIMENTS

An information processing apparatus according to one embodiment will hereinafter be described with reference to the drawings. A configuration of the embodiment is an exemplification, and the present information processing apparatus is not limited to the configuration of the embodiment.

### First Working Example

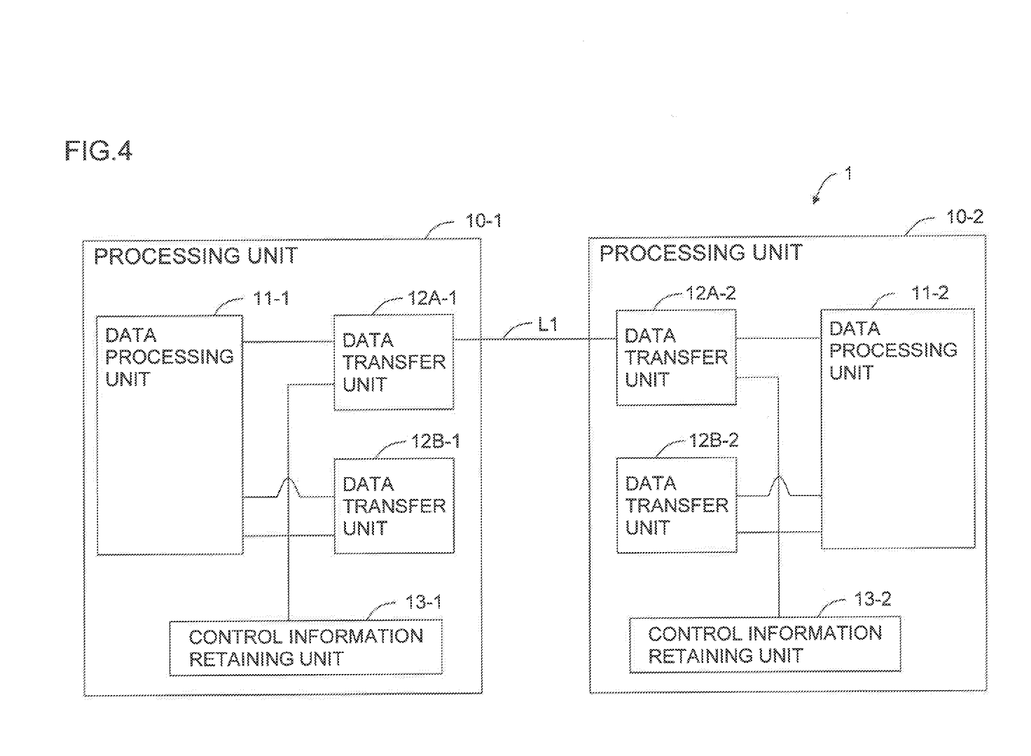

FIG. 4 illustrates a configuration of an information processing apparatus 1 according to a first working example. The information processing apparatus 1 can be exemplified as a variety of apparatuses such as a computer and a server. In the example of FIG. 4, the information processing apparatus 1 includes a processing unit 10-1 and a processing unit 10-2. The processing unit 10-1 and the processing unit 10-2 are, when generically termed, referred to as the processing unit 10. The processing unit 10 can be exemplified as a computer, a processor included in a server and a board like a system board including the processor. The processing unit 10 may, however, be an apparatus such as the computer and the server. If the processing unit 10 is the apparatus such as the computer and the server, the information processing apparatus 1 becomes a system including a plurality of computers, a plurality of servers, etc.

Further, the processing unit 10-1 includes a data processing unit 11-1, data transfer units 12A-1, 12B-1 and a control information retaining unit 13-1. The processing unit 10-2 has the same configuration as the processing unit 10-1 has. The processing unit 10-2 includes a data processing unit 11-2, data transfer units 12A-2, 12B-2 and a control information retaining unit 13-2. The data processing units 11-1, 11-2 are, when generically termed, referred to as the data processing unit 11. Further, the data transfer units 12A-1, 12B-1, 12A-2, 12B-2 are, when generically termed, referred to as the data transfer unit 12. The control information retaining units 13-1, 13-2 are, when generically termed, referred to as the control information retaining unit 13.

The processing unit 10-1 is one example of a transmitting device. Further, the processing unit 10-2 is one example of a receiving device. Still further, the data transfer unit 12A-1 is one example of a first output unit. Furthermore, the data processing unit 11-1 is one example of a first information processing unit. Still furthermore, the data processing unit 11-2 is one example of a second information processing unit.

The data processing unit 11 can be exemplified as, e.g., a processor serving as an arithmetic processing device or a circuit unit that executes data processing on the board etc including the processor, or a component. The data processing unit 11 includes components such as a CPU (Central Processing Unit) and a main storage device.

Further, the data transfer unit 12 can be exemplified as, e.g., a crossbar switch serving as a data transfer device, a processor, or a circuit unit that executes a data transfer on the board etc including the processor, or a component. The data transfer unit 12 includes, e.g., a buffer, a register, etc, which temporarily retain the data to be transferred. Moreover, the data transfer unit 12 includes a drive circuit for transmitting the data on the buffer or the register via a transmission link. Furthermore, the data transfer unit 12 includes a control circuit that controls the buffer and the register which temporarily retain the data, or the drive circuit etc that transfers the data. The control circuit includes a data switching circuit like, e.g., a switch.

In the configuration of FIG. 4, the processing unit 10-1 and the processing unit 10-2 are connected to each other by a transmission link L1 via the data transfer unit 12A-1 and the data transfer unit 12A-2. Note that the transmission link L1 may be a wired transmission link or may also be a wireless transmission link. Further, the transmission link L1 may be a parallel transmission link or may also be a serial transmission link. Still further, in the configuration of FIG. 4, the data transfer unit 12B-1 is not connected to an external device of the processing unit 10-1. Similarly, the data transfer unit 12B-2 is not connected to an external device of the processing unit 10-2. Namely, in FIG. 4, the data transfer units 12B-1, 12B-2 are provided as, e.g., standby units. It follows that each of the data transfer units 12B-1, 12B-2 is used when providing an extension of another processing unit 10 to the information processing apparatus 1.

The control information retaining unit 13 stores control information for controlling the data transfer unit 12. The control information retaining unit 13 includes a storage circuit called a latch, a register, etc. The data transfer unit 12 executes the data transfer according to the information stored by the control information retaining unit 13.

It is noted that FIG. 4 illustrates the two processing units 10-1 and 10-2, however, it does not mean that the number of the processing units is limited. Further, in FIG. 4, the processing unit 10-1 is provided with the two data transfer units 12A-1 and 12B-1. Still further, the processing unit 10-2 is provided with the two data transfer units 12A-2 and 12B-2. It does not, however, mean that the number of the data transfer units 12 in the processing unit 10 is limited. Namely, three or more data transfer units 12 may be provided within the processing unit 10.

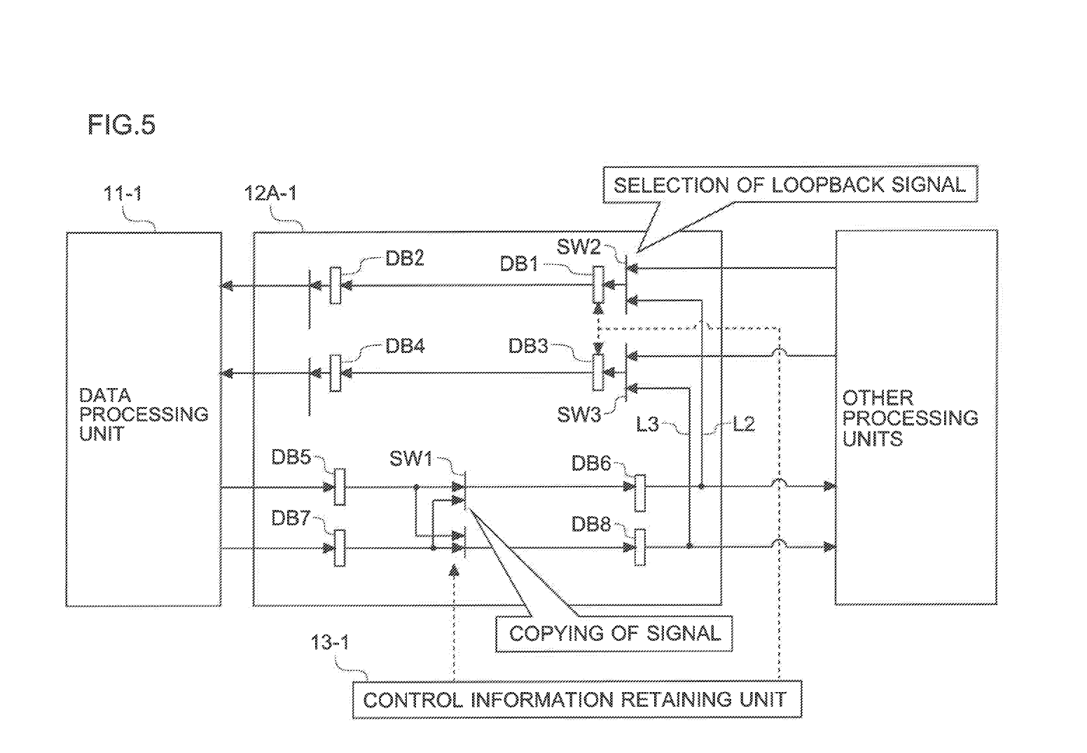

FIG. 5 is an in-depth illustration of the data transfer unit 12A-1. Herein, a description is made by taking, for example, a configuration of the data transfer unit 12A-1 included in the processing unit 10-1, however, other data transfer units 12 have the same configuration as the data transfer unit 12A-1 has.

The data transfer unit 12A-1 has data buffers DB1, DB3 that retain the data received from other processing units (10-2 etc). Herein, “other processing units” may further include one or more processing units in addition to the processing unit 10-2 depicted in FIG. 4. That is, a plurality of other processing units in FIG. 5 may be connected to the data transfer unit 12A-1. For instance, the data buffer DB1 receives reception data from the processing unit 10-2, while the data buffer DB3 is prepared for a prospective extension after shipping the product. In FIG. 5, however, the data buffers DB1, DB3 are connected to other processing units 10-2 etc via the switches SW2, SW3.

Further, the data transfer unit 12A-1 has data buffers DB2, DB4 for temporarily retaining the data in order to input the data in the data buffers DB1, DB3 to the data processing unit 11-1. The data buffer DB2 may, however, serve also as the data buffer DB1. Moreover, the data buffer DB4 may serve also as the data buffer DB3.

Further, the data transfer unit 12A-1 has data buffers DB5, DB7 for temporarily retaining the data processed by the data processing unit 11-1. Still further, the data transfer unit 12A-1 has data buffers DB6, DB8 for temporarily retaining the data in order to transfer the data in the data buffers DB5, DB7 to other processing units 10-2 etc. In FIG. 5, however, the data buffers DB6, DB8 are connected to the data buffers DB5, DB7 via the switch SW1.

The switch SW1 connects any one of the data buffers DB5, DB7 to the data buffer DB6. Moreover, the switch SW1 connects any one of the data buffers DB5, DB7 to the data buffer DB8. For example, as a first connection, the switch SW1 connects the data buffer DB5 to the data buffer DB6, and connects the data buffer DB7 to the data buffer DB8. The data processing unit 11-1 outputs the data transferred to other processing units 10-2 etc to each of the data buffers DB5, DB7, in which configuration the first connection is applied.

Moreover, as a second connection, the switch SW1 connects the data buffer DB5 to both of the data buffers DB6, DB8. The data processing unit 11-1 outputs the data transferred to other processing units 10-2 etc to the data buffer DB5 but does not output the data to the data buffer DB7, in which configuration the second connection is applied to when testing the information processing apparatus 1. Namely, in the case of the second connection, the data in the data buffer DB5 is transferred to the data buffer DB6 and is, after being copied, transferred also to the data buffer DB8. That is, in FIG. 5, the switch SW1 provides a signal copy function. The data buffer DB6 and the loopback line L2 are given as one example of a first output unit. The data buffer DB8 and the loopback line L3 are given as one example of a first output unit. The part of the switch SW1 to connect to the data buffer DB6 is one example of a first selection unit. The part of the switch SW1 to connect to the data buffer DB8 is one example of a second selection unit. Further, the data buffer DB5 is one example of a first retaining unit. Still further, the data buffer DB7 is one example of as a second retaining unit.

Note that a configuration of data transfer unit 12B-1 is, though not illustrated, the same as the configuration of the data transfer unit 12A-1. For example, the data transfer unit 12B-1 has the same configuration as the configuration of the switch SW1, the data buffer DB5 and the data buffer DB7.

Moreover, as a third connection, the switch SW1 connects the data buffer DB7 to both of the data buffers DB6, DB8. The data processing unit 11-1 outputs the data transferred to other processing units 10-2 etc to the data buffer DB7 but does not output the data to the data buffer DB5, in which configuration the third connection is applied to when testing the information processing apparatus 1. Namely, in the case of the third connection, the data in the data buffer DB7 is transferred to the data buffer DB8 and is, after being copied, transferred also to the data buffer DB6. That is, the switch SW1 provides the signal copy function.

Furthermore, in the data transfer unit 12A-1, the data output from the data buffers DB6, DB8 are transferred to other processing units 10-2 etc and, after being diverged along loopback lines L2, L3, input to switches SW2, SW3, respectively. The switch SW2 outputs any one of the data from other processing units 10-2 etc and the data from the loopback line L2 (the data buffer DB6) to the data buffer DB1. Further, the switch SW3 outputs any one of the data from other processing units 10-2 etc and the data from the loopback line L3 (the data buffer DB8) to the data buffer DB3.

The control information retaining unit 13-1 retains instruction bits that control switching of the switches SW1, SW2, SW3. In the example of FIG. 5, it may be sufficient that the control information retaining unit 13-1 retains a bit pattern of 4 bits as the instruction bits. For instance, a first instruction bit is a bit used for the switch SW1 to control an output signal to the data buffer DB6. Corresponding to the first bit, the switch SW1 outputs the data from any one of the data buffer DB5 and the data buffer DB7 to the data buffer DB6.

Moreover, a second instruction bit is a bit used for the switch SW1 to control the output signal to the data buffer DB8. Corresponding to the second bit, the switch SW1 outputs the data from any one of the data buffer DB5 and the data buffer DB7 to the data buffer DB8.

Furthermore, a third instruction bit is a bit used for the switch SW2 to control the output signal to the data buffer DB1. Corresponding to the third bit, the switch SW2 outputs the data from any one of other processing units 10-2 etc and the data buffer DB6 to the data buffer DB1.

Still further, a fourth instruction bit is a bit used for the switch SW3 to control the output signal to the data buffer DB3. Corresponding to the fourth bit, the switch SW3 outputs the data from any one of other processing units 10-2 etc and the data buffer DB8 to the data buffer DB3.

With the configuration such as this, in the processing unit 10-1, as the instruction bits set in the control information retaining unit 13-1, the data transfer unit 12A-1 operates as follows:

(1) Case of Processing Unit Taking Maximum Configuration; The “case of the maximum configuration” is a case where the data from other processing units are input to both of the data buffers DB1, DB3, and both of the data buffers DB6, DB8 output the data to other processing units. In FIG. 5, the two data buffers DB1, DB3 are provided for inputting the data, however, as a matter of course, three or more data buffers may also be provided for inputting the data. Further, in FIG. 5, the two data buffers DB6, DB8 are provided for outputting the data, however, as a matter of course, three or more data buffers may also be provided for outputting the data. Basically, however, the number of the data buffers for inputting the data is equal to the number of the data buffers for outputting the data.

In the case of the maximum configuration, it follows that both of the data buffer for inputting the data and the data buffer for outputting the data are connected to other processing units 10-2 etc. In this instance, it may be sufficient that the switch SW1 connects the data buffer DB5 to the data buffer DB6. Further, it may be sufficient that the switch SW1 also connects the data buffer DB7 to the data buffer DB8. Moreover, it may be sufficient that the switch SW2 inputs the data from other processing units 10-2 etc to the data buffer DB1. Still further, it may be sufficient that the switch SW3 inputs the data from other processing units 10-2 etc to the data buffer DB3. Accordingly, in this case, the data diverged by the loopback lines L2, L3 are discarded by the switches SW2, SW3 but not used.

### (2) Case of Number of Processing Units Being Smaller Than Number in Maximum Configuration;

In a case where the number of the processing units is smaller than the number in the maximum configuration, it follows that at least one of the data buffers DB1, DB3 for inputting the data is not connected to other processing units 10-2 etc. In FIG. 5, the two data buffers DB1, DB3 are provided for inputting the data, however, as a matter of course, the same is applied to the case of providing the three or more data buffers. Moreover, in the case where the number of the processing units is smaller than the number in the maximum configuration, it follows that at least one of the data buffers DB6, DB8 for outputting the data is not connected to other processing units 10-2. In FIG. 5, the two data buffers DB6, DB8 are provided for outputting the data, however, as a matter of course, the same is applied to the case of providing the three or more data buffers.

Described herein, by way of one example, is a case where the data buffer DB3 for inputting the data and the data buffer DB8 for outputting the data are not connected to other processing units 10-2 etc. In this case, it follows that a data input path inclusive of the data buffers DB3, DB4 is not used. Further, it is assumed that a path inclusive of the data buffer DB5, the switch SW1 and the data buffer DB6 is used for outputting the data. In this case, it follows that a path inclusive of the data buffer DB7, the switch SW1 and the data buffer DB8 is not used.

In this instance, on the occasion of testing the information processing apparatus 1, the first instruction bit of the control information retaining unit 13-1 is set to connect the data buffer DB5 to the data buffer DB6. Moreover, the second instruction bit is set to connect the data buffer DB5 to the data buffer DB8. That is, the data in the data buffer DB5 is copied and then output to the data buffer DB8.

Further, the third instruction bit is set to input the data from other processing units 10-2 to the data buffer DB1. Still further, the fourth instruction bit is set to input the data from the data buffer DB8 to the data buffer DB3. Accordingly, the data retained in the data buffer DB5 is transferred to other processing units 10-2 via the data buffer DB6 and is, after being copied by the switch SW1, returned to the data buffer DB3 via the switch SW3. The data buffer DB8 and the switch SW3 are given as one example of a first output unit.

As already described, the configuration of the data transfer unit 12B-1 is the same as the configuration of the data transfer unit 12A-1. Therefore, for instance, the data transfer unit 12B-1 has the same configuration as the configuration of the data buffer DB8 and the switch SW3.

Accordingly, a path inclusive of the data buffers DB3, DB4 is, even when not connected to other processing units 10-2 etc, enabled to input the data simulatively or in a pseudo manner by use of the data that is processed by the data processing unit 11-1 and is output to the data buffer DB5. The data input to the path inclusive of the data buffers DB3, DB4 is verified by an existing data verifying unit, e.g., a CRC (Cyclic Redundancy Check) checker, a parity checker and a protocol checker, etc.

Furthermore, the data retained in the data buffer DB8 for outputting the data is also verified by the existing data verifying unit on the path inclusive of the data buffers DB3, DB4. Moreover, the setting of the control information retaining unit 13-1 is changed to connect the data buffer DB7 in place of the data buffer DB5 to other processing units 10-2 etc, thereby enabling the test to be implemented between the data buffer DB7 and other processing units 10-2 etc similarly to the case of the data buffer DB5.

What has been discussed so far is the description of the case where the data buffer DB3 for inputting the data and the data buffer DB8 for outputting the data are not connected to other processing units 10-2 etc. The same test as described above can be implemented also in the case where the data buffer DB1 for inputting the data and the data buffer DB6 for outputting the data are not connected to other processing units 10-2 etc.

Further, what has been discussed so far is the description by taking the data transfer unit 12A-1 for example. The process, the function and the operation of the data transfer unit 12B-1 defined as the second output unit are, however, the same as those of the data transfer unit 12A-1. Moreover, what has been discussed so far is the description by taking mainly the processing unit 10-1 as the transmitting device for example. However, the process, the function and the operation of the processing unit 10-2 defined as the receiving device are the same as those of the processing unit 10-1. For instance, the processing unit 10-2 includes the data processing unit 11-2 as a second information processing unit and provides the same function as the function of the processing unit 10-1.

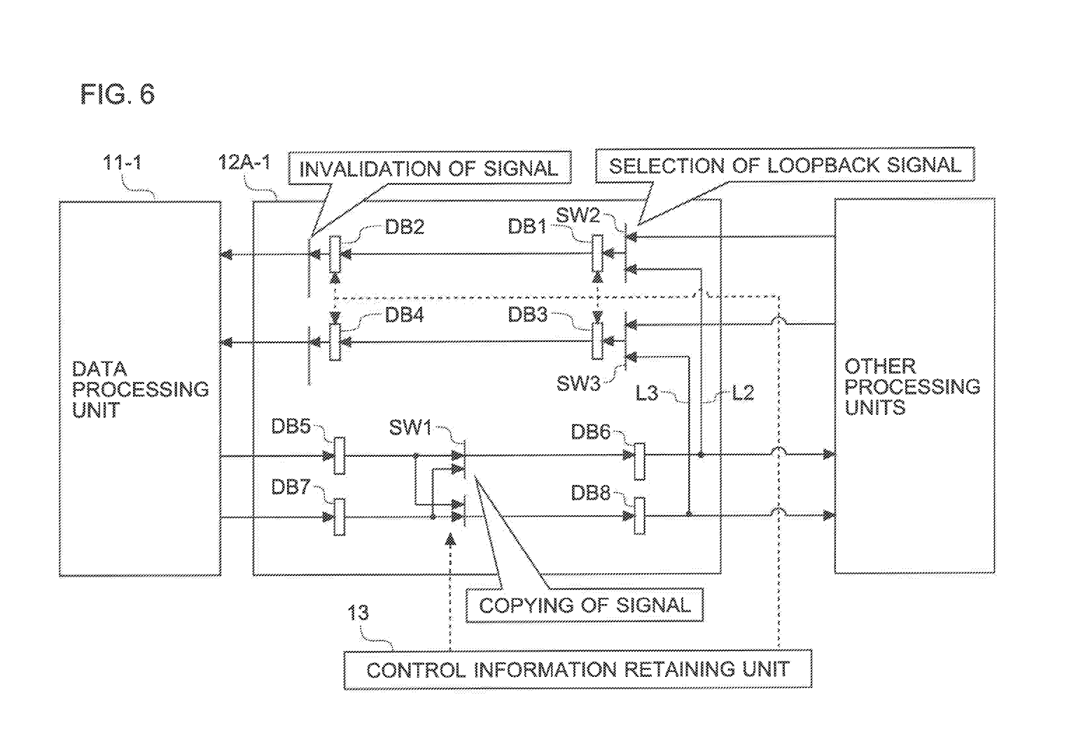

FIG. 6 is a diagram illustrating a configuration that invalidates the signals. In the first working example, as in FIG. 5, if the number of the processing units 10 is smaller than the number of the processing units 10 when making the maximum configuration, the data of the data buffer DB5 etc, which is output to other processing units 10-2 etc, is so turned back as to be input to the path inclusive of the data buffer DB3. Such a process being executed, it follows that the data processing unit 11-1 receives the input of the data, which is not originally received, from the path inclusive of the data buffer DB3. As a result, there is a possibility that a contradiction occurs in the process of the data processing unit 11-1 when implementing the test. This being the case, such a mechanism is employed that the data received from the loopback path is invalidated just before the data processing unit 11-1.

In the example of FIG. 6, the signals of the control information retaining unit 13-1 are input also to the data buffer DB2 and the data buffer DB4. The control information retaining unit 13-1 is further provided with fifth and sixth instruction bits in addition to the first through fourth instruction bits.

The fifth instruction bit is used for the control to enable or disable the output of, e.g., the data buffer DB2. For example, it may be sufficient that the fifth instruction bit is used for controlling a cut-off circuit such as a TRI-STATE buffer for cutting off between the input and the output of the data buffer DB2 in a high impedance state and an AND gate. Alternatively, the fifth instruction bit may be made to function as, e.g., a valid flag for indicating valid/invalid states of the output of the data buffer DB2.

Similarly, the sixth instruction bit is used for controlling the output of, e.g., the data buffer DB4 to be enabled or disabled. Further, the sixth instruction bit may be made to function as, e.g., the valid flag for indicating the valid/invalid states of the output of the data buffer DB4.

With this configuration, for instance, when the data in the data buffers DB5, DB7, etc are turned back and thus input to the path inclusive of the data buffer DB3, it may be sufficient that the data in the data buffer DB4 is invalidated by the sixth instruction bit. Similarly, when the data in the data buffers DB5, DB7, etc are turned back and thus input to the path inclusive of the data buffer DB1, it may be sufficient that the data in the data buffer DB2 is invalidated by the fifth instruction bit.

The cut-off circuit which cuts off between the input and the output of the data buffer DB2 or DB4 etc in the high impedance state or the valid flag for indicating the valid/invalid states of the outputs of the data buffers DB2, DB4, etc, is given by way of an example of an invalidating unit.

As discussed above, the information processing apparatus 1 according to the first working example can, with the contrivance that the number of the processing units 10 is not the number in the maximum configuration, implement the test in the state approximate to the case of extending the processing units but actually with no extension of the processing units even in the case of including the unused interface circuits, e.g., the data buffers DB3, DB7, DB8, etc in FIG. 5. For example, the data buffers DB1, DB2 are used for inputting the data, and the data buffers DB5, DB6 are used for outputting the data, in which case the data in the data buffer DB5 is copied. Then, the copied data is output to the unused data buffer DB8 and further input to the unused data buffer DB3 via the loopback line L3 diverging from the path to the processing unit 10-2 serving as a transfer destination unit. As a result, it may be sufficient that the data transferred via the unused path inclusive of the data buffers DB3, DB4 are verified by the existing data verifying unit. Furthermore, the turned-back data is invalidated in the data buffer DB4 before being input to, e.g., the data processing unit 11-1, whereby the contradiction within the data processing unit 11-1 can be restrained from occurring.

The configuration such as this is provided in each of the data transfer units 12A-1, 12B-1, 12A-2, 12B-2, etc of the processing units 10-1, 10-2 illustrated in FIG. 4. Accordingly, the information processing apparatus 1, the processing unit 10-1 as the transmitting device and the processing unit 10-2 as the receiving device can implement the test in which to activate the greatest possible number of portions not with the maximum configuration but with the configuration enabling the prospective extension or the configuration that is as approximate to the single unit as possible.

Moreover, the test described above can be simply controlled through the switchover of the switches SW1 to SW3 and the invalidation of the data buffers DB2, DB4, etc by setting the instruction bits of the control information retaining unit 13-1.

### Modified Example

The first working example has demonstrated the example in which the control information retaining unit 13 indicates the switchover of the switches SW1-SW3 by use of the first through sixth instruction bits representing the connections of the switches and indicates whether the data buffers DB2, DB4, etc are invalidated or not in FIGS. 5 and 6. In the configuration of the first working example, so to speak, the control information is set for every instruction target element such as the switches SW1-SW3 etc or the data buffer DB2 etc. As a substitute for this configuration, the control information retaining unit 13 may retain the instruction bits corresponding to other processing units 10-2 etc as the connection destinations. For instance, if totally four pieces of other processing units 10 can be connected to the processing unit 10-1, information indicating whether connected to four other processing units 10 or not may be set as four instruction bits in a control signal TEST_MODE[0:3] representing a test status, which is specified by JTAG (Joint Test Architecture Group) Standards of IEEE1149.1. For instance, TEST_MODE[i]=0 represents that the processing unit 10-1 is connected to another processing unit 10-i, while TEST_MODE[i]=1 represents that the processing unit 10-1 is not connected to another processing unit 10-i. FIGS. 4, 5 and 6 illustrates the processing units 10-1 and 10-2, however, the following description will be made on the assumption that the number of the processing units 10 is equal to or larger than “2”. Furthermore, the description will be made on the assumption that a further output signal line is provided other than the output signal line inclusive of the data buffers DB5, DB6 and the output signal line inclusive of the data buffers DB7, DB8. Moreover, the description will be made on the assumption that a further input signal line is provided other than the input signal line inclusive of the switch SW2 and the data buffers DB1, DB2 and the input signal line inclusive of the switch SW3 and the data buffers DB3, DB4. Further, the description will be made on the assumption that another loopback line is provided other than the loopback lines L2, L3 in a way that corresponds to the output signal line and the input signal line.

It may be sufficient that the test is implemented, in which the control information retaining unit 13 predetermines the switchover of the switches SW1-SW3 and whether the data buffers DB2, DB4, etc are invalidated or not on the basis of the instruction bits of the control information retaining unit 13 described above. For example, if all bits of TEST_MODE[0:3] are “0”, this indicates that the processing unit 10-1 is connected to all other processing units 10-i (i=2, 3, 4, 5). In this case, it may be sufficient that the switch SW1 connects, without copying the signal, the data buffer DB5 directly to the data buffer DB6 and the data buffer DB7 directly to the data buffer DB8.

Further, it may be sufficient that the switches SW2, SW3, etc connect not the signals from the loopback lines L2, L3 but the signals from other data processing units 10 directly to the data buffers DB1, DB3, etc. Moreover, it may be sufficient that the signals are not invalidated in the data buffers DB2, DB4, etc.

While on the other hand, for instance, if any one or more of bits of TEST_MODE[0:3] are “1”, it follows that the data processing unit 10-1 is not connected to any one or more of other data processing units 10. In this case, any one of the data buffers DB6, DB8, etc on the data output side is not connected to other data processing units 10. Further, any one of the data buffers DB1, DB3, etc on the data input side is not connected to other data processing units 10. In this instance, it may be sufficient that the switch SW1 copies the signals of the data buffer, corresponding to the bit position of TEST_MODE[0] through TEST_MODE[3] with the bit “0” being set, to the data buffer corresponding to the bit position with the bit “1” being set. For example, when TEST_MODE[0]=0 and if all bits of TEST_MODE[1:3] are “1”, it may be sufficient that the signals of the data buffer DB5 corresponding to the bits of TEST_MODE[0] are input to the data buffer DB6 and, in addition, copied to other data buffers DB8 etc.

On the other hand, it may be sufficient that the switch SW3 etc corresponding to TEST_MODE[1:3] select the signals on the loopback line L2 etc. Moreover, it may be sufficient that the data buffer DB4 etc corresponding to TEST_MODE[1:3] etc invalidate the signals. As described above, it may be sufficient to switch between (1) receiving the signals from other data processing units 10 and (2) using the signals from the paths through a series of processes of copying, turning back and invalidating the signals, depending on TEST_MODE[i] indicating whether connected to other data processing units 10 or not.

### Second Working Example

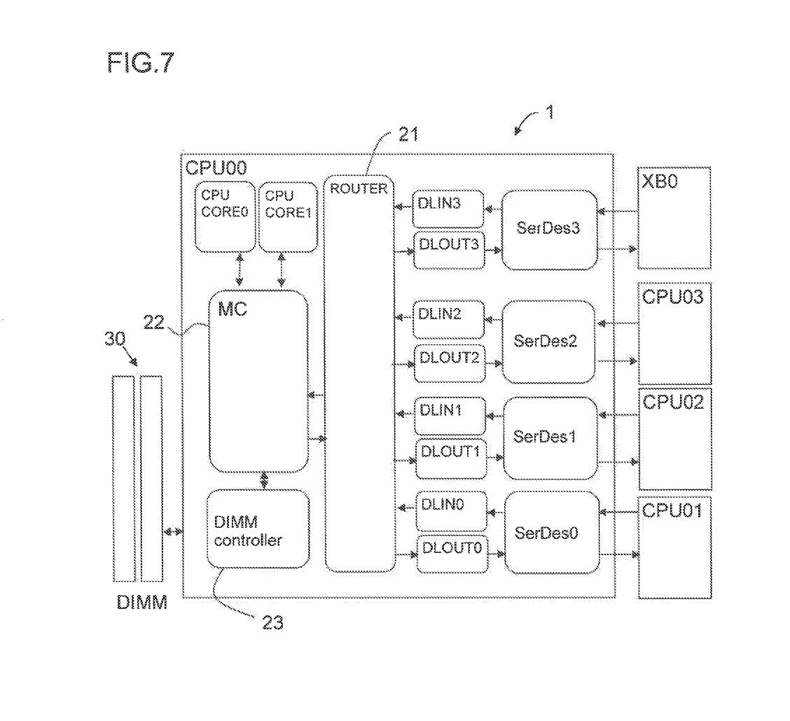

The information processing apparatus 1 according to a second working example will be described with reference to FIGS. 7 through 16. Also in the second working example, the configuration of the information processing apparatus 1 is basically the same as in the first working example. This being the case, in the second working example, the same components as those in the first working example are marked with the same numerals and symbols, and their explanations are omitted.

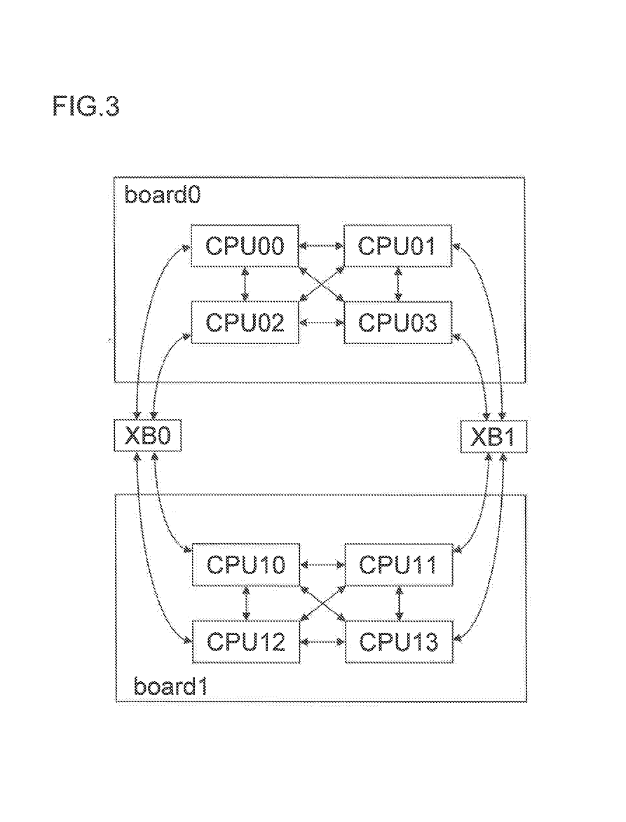

FIG. 7 is a diagram illustrating the configuration of the information processing apparatus 1 according to the second working example. The information processing apparatus 1 according to the second working example includes, in the maximum configuration, e.g., as depicted in FIG. 3, a CPU00 through a CPU03, a CPU10 through a CPU13 and crossbar switches XB0, XB1. FIG. 7 illustrates, in the information processing apparatus 1 with the maximum configuration, the CPU00 through the CPU03 and the crossbar switch XB0. Further, a DIMM (Dual Inline Memory Module) 30 is connected to the CPU00. The DIMM 30 is, e.g., an SDRAM (Synchronous Dynamic Random Access Memory). The DIMM 30 is connected to an MC (Memory Controller) 22 via a DIMM controller 23 within the CPU00. The DIMM 30 is used as a memory for a further extension of the capacity of the main storage device in the CPU00.

As in FIG. 7, the CPU00 has, e.g., two cores, i.e., CPU CORE0 and CPU CORE1. It does not, however, mean that the number of the cores possessed by the CPU00 is limited to “2”. A plurality of cores will hereinafter be simply termed CPU CORE0 etc. Moreover, as illustrated in FIG. 7, the CPU00 etc includes the MC 22, the router 21 and the DIMM controller 23.

The CPU CORE0 etc executes processing the data in the CPU00 by use of a computer program deployed in an executable manner on the main storage device or the DIMM 30. In the data processing, the CPU CORE0 etc accesses the main storage device via the MC 22. For example, the CPU CORE0 etc, if processing target data does not exist on the unillustrated cache, requests the MC 22 to acquire the data.

The MC 22 retains the storage destination of the data requested for its acquisition. Then, the MC 22 executes a process of reading the data from the storage destination of the acquisition requested data as a data acquisition requesting destination. For example, the MC 22 reads, if the destination of the data acquisition request given from the CPU CORE0 etc is the main storage device in the CPU00 or the DIMM 30, the data from an acquisition requested address, and hands over the readout data to the requester CPU CORE0 etc. Further, the MC 22 hands over the data acquisition request to the router 21 if the destinations of the data acquisition request given from the CPU CORE0 etc are other CPU01 through CPU03 or other CPUs connected via the XB0.

The router 21 specifies, based on logical information of the CPU designated as the data acquisition destination set in the data acquisition request given from the MC, the I/O interface connected to the designated CPU. For example, if the CPU01 is designated as the data acquisition destination, the router 21 outputs the data acquisition request addressed to the CPU01 to an output interface DLOUT0. The data requested for its acquisition is input to, e.g., an input interface DLIN0 from the CPU01, and hence the router 21 hands the data input to the input interface DLIN0 over to the MC 22.

Further, e.g., the CPU CORE0 etc requests the MC 22 to save the processed data in the main storage device or the main storage device of another CPU. The MC 22 retains the storage destination of the data requested to be saved. Then, the MC 22 executes a process of writing the data to the storage destination of the data requested to be saved as a data write request destination. For example, the MC 22 writes, if the destination of the data write request given form the CPU CORE0 etc is the main storage device in the CPU00 or the DIMM 30, the data to an address requested for writing. Moreover, the MC 22 hands over the data write request to the router 21 if the destinations of the data write request given from the CPU CORE0 etc are other CPU01 through CPU03 or other CPUs connected via the XB0.

The router 21 specifies, based on the logical information of the CPU designated in the data write request given from the MC, the I/O interface connected to the designated CPU. For instance, if the CPU01 is designated as the data write request destination, the router 21 outputs the write request target data addressed to the CPU01 to the output interface DLOUT0.

The same processing as done for the interfaces DLIN0 and DLOUT0 is applied to other input interfaces DLIN1 through DLIN3 and other output interfaces DLOUT1 through DLOUT3. The output interfaces DLOUT0 through DLOUT3 and the input interfaces DLIN0 through DLIN3 correspond to functions of a data link layer of, e.g., a communication protocol hierarchy.

In FIG. 7, parallel/serial converting units (which will hereinafter be simply referred to as converting units) SerDes0 through SerDes3 are connected to the output interfaces DLOUT0 through DLOUT3 and the input interfaces DLIN0 through DLIN3. The converting unit SerDes0 etc, when receiving parallel signals from the output interface DLOUT0 etc, converts the parallel signals into serial signals and transfers the serial signals to other CPU01 etc. Further, the converting unit SerDes0 etc, when receiving the serial signals from other CPU01 etc, converts the serial signals into the parallel signals and inputs the parallel signals to the input interface DLIN0 etc. The converting unit SerDes0 etc has a configuration including plural stages of combinations of circuits that generate two types of clocks having a frequency ratio of 1:2 by dividing a clock into, e.g., a 1/2 frequency and multiplexers that multiplex the data at a ratio of 2:1. However, the configuration of the converting unit SerDes0 etc is omitted.

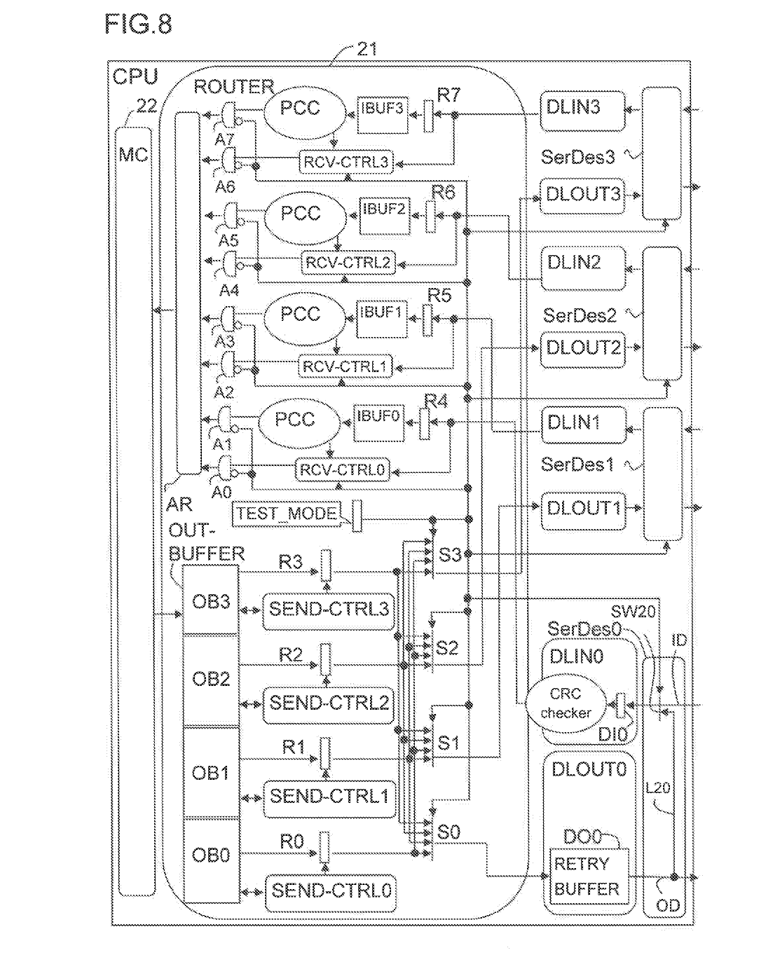

FIG. 8 illustrates an in-depth configuration of the router 21 in the CPU00 together with peripheral circuits of the router 21. In the second working example, the data transferred and received between the CPU00 through CPU03 and the CPU10 through the CPU13 will hereinafter be called packets. The CPU00 through CPU03 will hereinafter be notated such as CPU00-03. The CPU10 through the CPU13 are likewise notated such as CPU10-13. The same notation is applied to SerDes, DLIN, DLOUT, etc.

As already explained in FIG. 7, for instance, the CPU00 includes the converting units SerDes0-3, the input interfaces DLIN0-3 and the output interfaces DLOUT0-3. Note that the input interfaces DLIN0-3 and the output interfaces DLOUT0-3 take charge of controlling the interfaces between the converting units SerDes0-3 and the router 21.

FIG. 8 illustrates details of the input interface DLIN0, the output interface DLOUT0 and the converting unit SerDes0. The input interface DLIN0 has, e.g., the input buffer DI0 and the CRC checker. Accordingly, the input data stored in the input buffer DI0 is CRC-checked in the input interface DLIN0. The input interface DLIN0 may be a hardware circuit or may be a processing unit provided in such a way that the DSP executes the computer program.

Each of the output interfaces DLOUT0-3 may be a hardware circuit including the buffer and may also be a function provided by the DSP executing the computer program. In FIG. 8, for instance, the output interface DLOUT0 has a retry buffer DO0. The packet of the retry buffer DO0 is handed over to the converting unit SerDes0.

The converting unit SerDes0 has a switch SW20 and a loopback line L20 that diverges and turns back the data OD transferred to another CPU to the switch SW20. Namely, the converting unit SerDes0 executes the parallel/serial conversion that is already explained in FIG. 7 and, in addition, turns the output data OD back via the loopback line L20.

Further, the switch SW20 selects any one of input data ID input from another CPU and turn-back data from the loopback line L20, and hands over the selected data to the input interface DLIN0. The converting unit SerDes0 is one example of a first output unit. Similarly, the converting unit SerDes1 is one example of a second output unit.

The processes of other input interfaces DLIN1-3, the output interfaces DLOUT1-3 and the converting units SerDes1-3 are the same as those of the input interface DLIN0, the output interface DLOUT0 and the converting unit SerDes0.

As in FIG. 8, the router 21 includes output buffers OB0-3 for receiving the packets issued from the MC 22 that controls issuance of the packet to the outside, e.g., another CPU, and transmitting control units SEND-CTRL0-3 for reading the packets from the respective output buffers OB0-3 and transmitting the packets to the output interfaces DLOUT0-3. The router 21 further includes registers R0-3 stored with the packets that are read from the output buffers OB0-3, and bus selectors S0-3 for selecting a bus when in a test mode. The bus selector S0 is one example of a first selection unit. Moreover, the bus selector S1 is one example of a second selection unit.

Still further, the router 21 includes registers R4-7 that receive the packets from the input interfaces DLIN0-3, buffers IBUF0-3 for storing the received packets, receiving control units RCV-CTRL0-3 that control writing the packets to the IBUFs and transmitting the packets to the MC 22, and an arbitration circuit AR that processes a conflict of reading the packets from the IBUF0-3. Furthermore, the router 21 has the control information retaining unit 13 for setting whether in the test mode or not. The control information retaining unit 13 includes a latch stored with test mode bits TEST_MODE[0:3].

The registers R4-7 are provided corresponding to the input interfaces DLIN0-3 and retain the data given from the input interfaces DLIN0-3. Each of the registers R4-7 is, e.g., a latch that retains the data for one packet.

Moreover, for instance, the buffer IBUF0 is connected at a stage next to the register R4. It may be sufficient that the register R4 retains the data for one packet, while the buffer IBUF0 retains the data for a plurality of packets. Herein, “one packet” contains a data field (payload) to which a predetermined bit count such as 8 bits, 16 bits, 32 bits and 64 bits is allocated.

Further, a data verifying unit PCC (Parity & Protocol checker) is provided at the next stage to the buffer IBUF0. The data verifying unit PCC executes the CRC (Cyclic Redundancy Check) check, the parity check and executes checking whether the data format and the data transmission procedure are based on a predetermined protocol with respect to the data handed over to the MC 22 from the buffer IBUF0. The data verifying unit PCC can be exemplified as a hardware circuit that executes arithmetic operations of the CRC check, the parity check, the protocol check, etc. The DSP (Data Signal Processor) etc may, however, function as the data verifying unit PCC by executing the computer program.

Moreover, as in FIG. 8, the receiving control unit RCV-CTRL0 is provided in parallel with the path extending through the register R4, the buffer IBUF0 and the data verifying unit PCC. The receiving control unit RCV-CTRL0, when the data for one or more packets exist in the buffer IBUF0, requests the MC 22 to input the data via the arbiter AR. The process of the receiving control unit RCV-CTRL0 may be realized by the hardware circuit such as the latch and a counter and may also be provided by the DSP executing the computer program. Note that the circuit portion including the receiving control unit RCV-CTRL0, the register R4, the buffer IBUF0 and the data verifying unit PCC is called an input unit and is one example of a first input unit. Similarly, the circuit portion including the receiving control unit RCV-CTRL1, the register R5, the buffer IBUF1 and the data verifying unit PCC is also called the input unit and is one example of a second input unit. Note that the circuit portion including the receiving control unit RCV-CTRL2 etc and the circuit portion including the receiving control unit RCV-CTRL3 etc are also called the input units.

The arbiter AR in FIG. 8 is the arbitration unit for arbitrating the data input process between the MC 22 and the plurality of input units. To be specific, the arbiter AR, if the data input requests are given from a plurality of units among the receiving control units RCV-CTRL0-3, determines which input request is prioritized based on predetermined standards. There is no particular limit to the standards for priority levels of the input request. For example, the input request may be determined by round robin. Further, for instance, each input unit may notify the arbiter AR of the number of retained packets. For example, it may be sufficient that the receiving control units RCV-CTRL0-3 notify the arbiter AR of the number of packets retained in the buffers IBUF0-3 together with the input requests. Then, it may also be sufficient that the arbiter AR arbitrates the data input by prioritizing the input unit retaining a larger number of packets.

Moreover, as in FIG. 8, AND gate trains A0-7 are provided to the transmission paths extending from the data verifying units PCC and the receiving control units RCV-CTRL0 etc to the arbiter AR. These AND gate trains A0-7 enable or disable the data input requests given to the arbiter AR from the receiving control units RCV-CTRL0 etc. Further, these AND gate trains A0-7 enable or disable the data input, to the arbiter AR, of the already-verified data input from the data verifying units PCC. For example, in the case of validating the data of the input interface DLIN0 and handing over the validated data to the MC 22, the control information retaining unit 13 supplies enable signals to the AND gate A0 connected to the receiving control unit RCV-CTRL0 and to the AND gate A1 connected to the register R4, the buffer IBUF0 and the data verifying unit PCC, i.e., supplies logical values “0” to the AND gates A0, A1. Moreover, in the case of invalidating the data of the input interface DLIN0 and not handing over the data to the MC 22, these AND gates A0, A1 are supplied with disable signals, i.e., logical values “1”.

The same process is applied to other AND gates, e.g., the AND gate A2 connected to the receiving control unit RCV-CTRL1 and the AND gate A3 connected to the path inclusive of the register R5, the buffer IBUF1 and the data verifying unit PCC. Further, the same process is applied to the AND gate A4 connected to the receiving control unit RCV-CTRL2 and the AND gate A5 connected to the path inclusive of the register R6, the buffer IBUF2 and the data verifying unit PCC. Still further, the same process is applied to the AND gate A6 inclusive of the receiving control unit RCV-CTRL3 and the AND gate A7 connected to the path inclusive of the register R7, the buffer IBUF3 and the data verifying unit PCC. In FIG. 8, the AND gates A0-7 are given as one example of an invalidating unit. Transistors capable of cutting off the inputs to the arbiter AR may, however, be used in place of the AND gates.

The output buffers OB0-3 retain the data supplied to the registers R0-3. Then, for instance, the transmitting control unit SEND-CTRL0, when the output data exists in the output buffer OB0, executes controlling to read the data for one packet to the register R0. The process of the transmitting control unit SEND-CTRL0 may be carried out by the hardware circuit and may also be carried out in such a manner that the DSP executes the computer program.

Each of the bus selectors S0-S3 selects the data from any one of the registers R0-R3 and outputs the selected data to the respective output interfaces DLOUT0-3. The register R is one example of a first retaining unit. Further, the register R1 is one example of a second retaining unit.

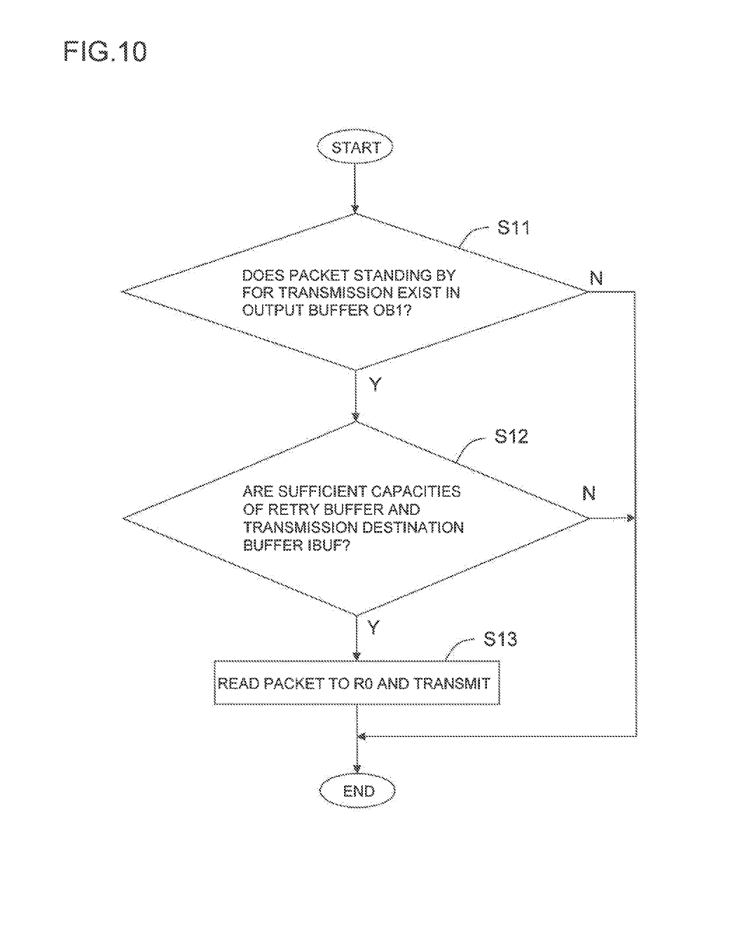

Next, a packet transmission process when in a normal operation of the CPU00 depicted in FIG. 8 will hereinafter be described. The “normal operation” connotes not when testing but when normally operating. In the case of transmitting the packet from the CPU00 to the CPU01, the packet is written to the output buffer OB0 from the MC 22 of the CPU00. Next, the packet transmitting control unit SEND-CTRL0 of the CPU00 transmits the packet to the output interface DLOUT0 in accordance with an operation flow illustrated in FIG. 10. The packet transferred to the output interface DLOUT0 is forwarded to the converting unit SerDes0 of the CPU01 via the buffer DO0 and the converting unit SerDes0 of the CPU00.

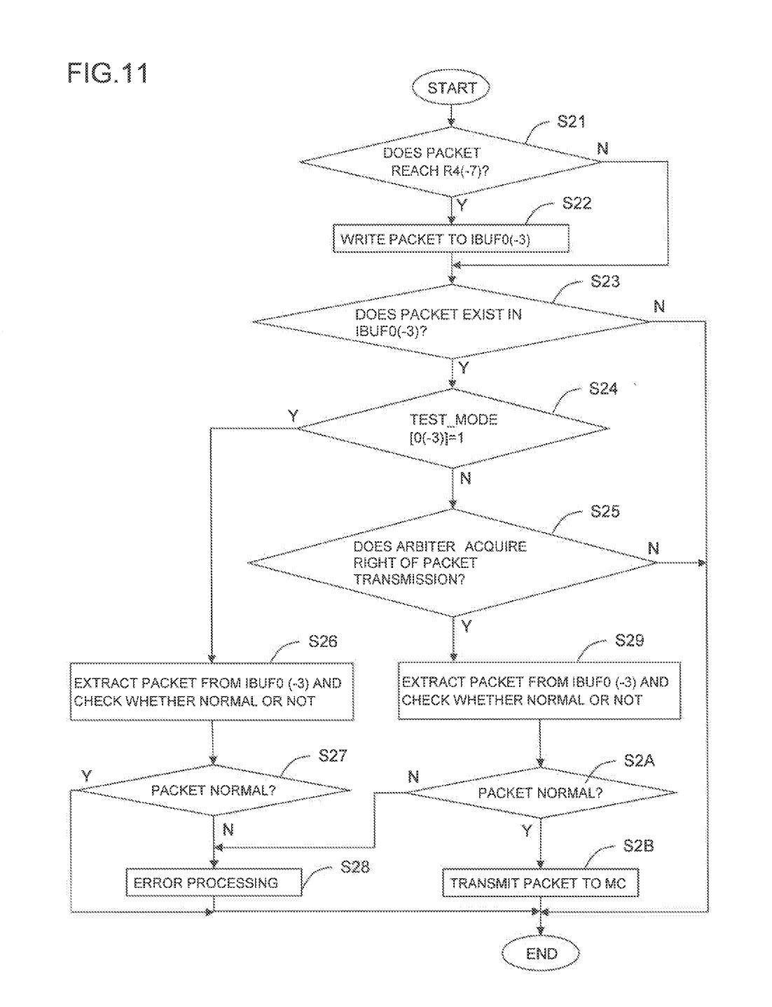

The packet received by the SerDes0 of the CPU1 is transferred to the DLIN0 of the CPU01 and is, after the packet has been confirmed normal by the CRC check etc, transmitted to the R4 of the CPU01. The packet transmitted to the R4 of the CPU01 is written to the buffer IBUF0 and then transmitted to the MC 22 according to the operation flow illustrated in FIG. 11. The packet transmission to the CPU02, CPU03 and the crossbar switch XB0 from the CPU00 is carried out in the same way.

Next, a process of the packet transmission when in the testing operation of the CPU00 will hereinafter be described. The testing operation of the CPU00 becomes valid by setting a value in the test mode bit TEST_MODE[0:3] of the control information retaining unit 13. The bus selectors S0-S3, the converting units SerDes0-3 and the receiving control units RCV-CTRL0-3 are notified of the value of TEST_MODE[0:3], and each of the function blocks changes its operation based on the value of TEST_MODE[0:3]. The setting of the value with respect to the control information retaining unit 13 is done from outside by making use of an interface with a testing function provided in a JTAG-LSI and I2C (Inter-Integrated Circuit)-LSI. It does not, however, mean that the setting of the value with respect to the control information retaining unit 13 is limited to JTAG and I2C.

The JTAG is defined as the standards by which the internal circuit of the LSI chip performs communications with a device outside the LSI chip. The interior of the LSI chip that conforms to the JTAG standards is prepared with signal terminals for indicating a clock, a data input, a data output and status control, and the test called a boundary scan test is implemented over the LSI chip through these signal terminals. The I2C is defined as standards by which the interior of the LSI etc performs serial communications with the device etc outside the LSI chip. Note that 4 bits are exemplified as the bit count retained in the control information retaining unit 13 in the second working example. It does not, however, mean that the bit count retained in the control information retaining unit 13 is limited to 4 bits. Namely, it may be sufficient that the bit count of the test mode bit TEST_MODE is determined corresponding to the number of the CPUs of the peer device to which the CPUs (on this side) are connected.

TEST_MODE[0:3] is the set value per interface, in which “0” is set for the interface with the connecting destination on which actually the chip (peer CPU) exists, and “1” is set for the interfaces with no connecting destination of an actual existing chip.

When in the normal operation, the test mode bits are set such as TEST_MODE[0:3]=0000. Now, for instance, a CPU00-CPU01 path inclusive of DLIN0 and DLOUT0 is called an interface 0. Further, generally, a CPU00-CPU0i path inclusive of DLINi and DLOUTi is called an interface i. Herein, the value “i” is 1 or 2 or 3. The interface 0 is set in the normal operation, while other interfaces 1, 2, 3 are set in the test mode, in which case the test mode bits are set such as TEST_MODE[0:3]=0111. The number of the interfaces, however, depends on the number of the CPUs of the connectable peer device, and hence it does not mean that the number of the interfaces is limited to “4”.

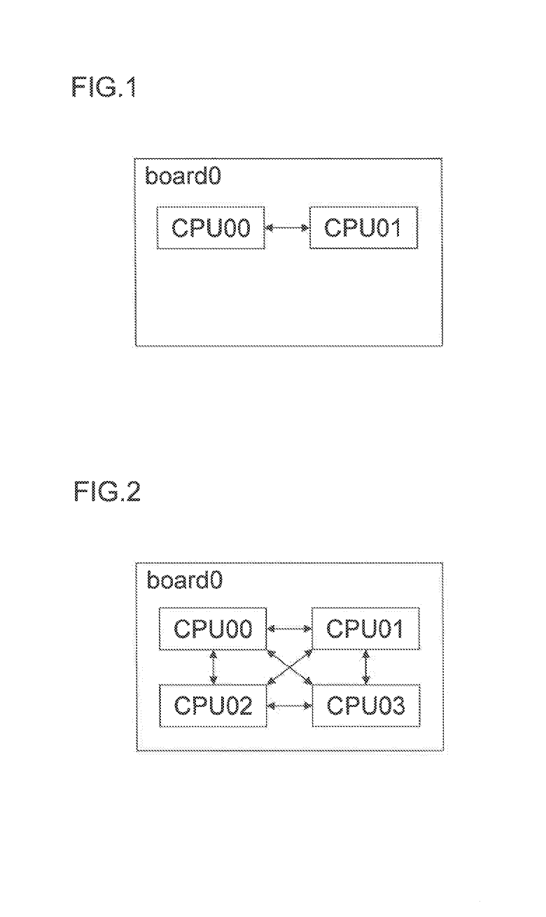

An operation when TEST_MODE[0:3]=0111 will hereinafter be demonstrated. TEST_MODE[0:3]=0111 is demonstrated in the configuration of FIG. 1. In FIG. 1, in the status where the CPU00 is connected to the CPU01, while other CPUs and relay chips (the crossbar switches XB0, XB1, etc) are not connected. Accordingly, an assumption is that the information processing apparatus 1 includes the CPU00 and the CPU01, and the test is implemented in the way of including the communications with other CPUs.

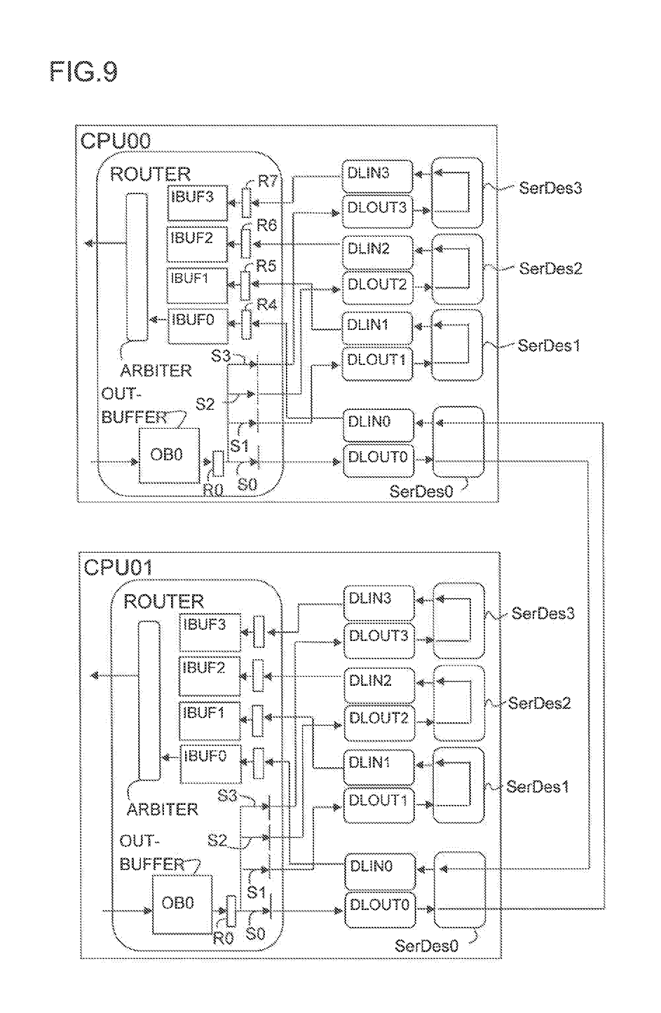

FIG. 9 illustrates a logical connecting relation when setting TEST_MODE[0:3]=0111. The signal of the register R0 is transmitted directly to the output interface DLOUT0 through the bus selector S0 in both of the CPU00 and the CPU01 because of TEST_MODE[0]=0. Furthermore, the signals of the interfaces 0, i.e., the input interface DLIN0 and the output interface DLOUT0 undergo the parallel/serial conversion in the converting unit SerDes0, thereby establishing the mutual connection between the CPU00 and the CPU01. That is, the signal of the output interface DLOUT0 of the CPU00 is connected to the input interface DLIN0 of the CPU01. Further, the signal of the output interface DLOUT0 of the CPU01 is connected to the input interface DLIN0 of the CPU00.

On the other hand, because of TEST_MODE[1:3]=111, the signals of the register R0 are copied in the bus selectors S1, S2, S3 and handed over to the output interface DLOUT1, DLOUT2, DLOUT3. Moreover, the signals of the output interface DLOUT1 are turned back at the converting unit SerDes1 and returned to the input interface DLIN1. Similarly, the signals of the output interface DLOUT2 are turned back at the converting unit SerDes2 and returned to the input interface DLIN2. Further similarly, the signals of the output interface DLOUT3 are turned back at the converting unit SerDes3 and returned to the input interface DLIN3.

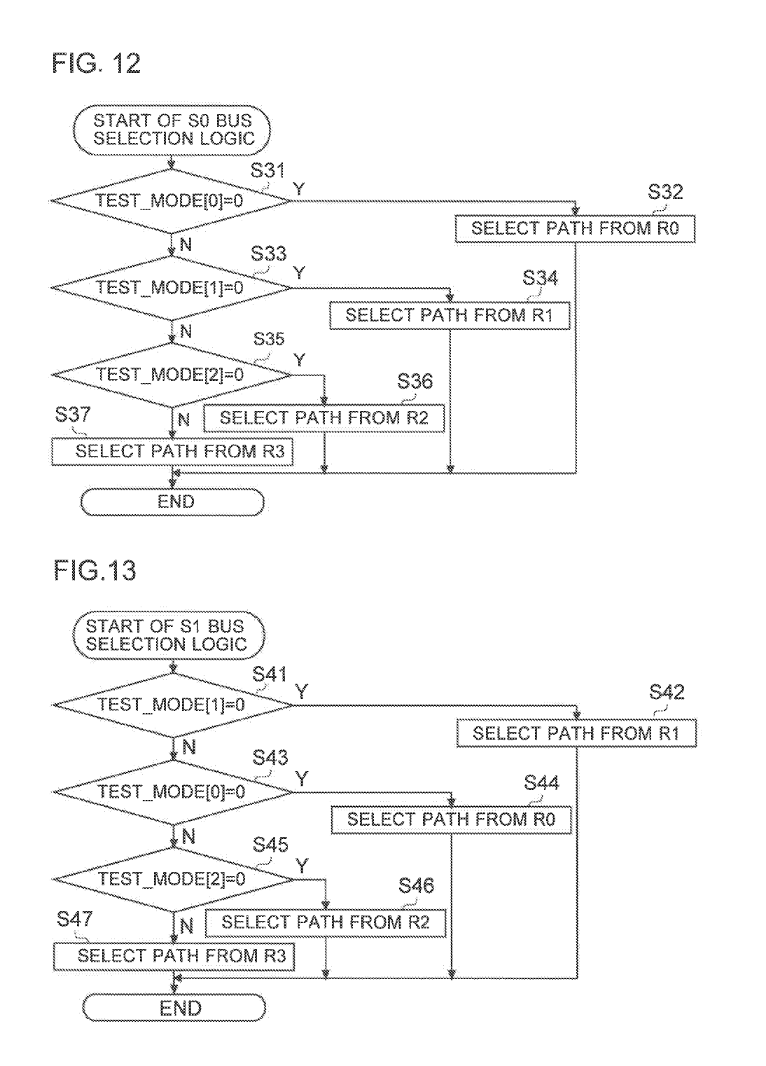

In the case of forwarding the packet to the CPU01 from the CPU00, the packet is written first to the output buffer OB0 from the MC 22 of the CPU00. Next, the packet transmitting control unit SEND-CTRL0 of the CPU00 transmits the packet to the output interface DLOUT0 via the register R0 in accordance with the operation flow illustrated in FIG. 10. Herein, the bus selectors S0-S3 follow the bus selection logics depicted in FIGS. 12-15. When in the normal operation (TEST_MODE=0000), the bus selector S0 selects the register R0, the bus selector S1 selects the register R1, the bus selector S2 selects the register R2, and the bus selector S3 selects the register R3. Whereas when TEST_MODE[0:3]=0111, as described above, all the bus selectors S0-S3 select the signal from the register R0. As a result, the packets coming from the CPU00 are transferred to the output interface DLOUT0, and the copied packets are forwarded to the DLOUT1, the DLOUT2 and the DLOUT3.

The packets forwarded to the respective output interface DLOUT0-3 are transmitted to the converting units SerDes0-3. As described above, the converting units SerDes0-3 become the loopback mode to turn back the transmission signals of the converting units themselves when the bits, corresponding to their interface numbers, of TEST_MODE[0:3] are “1”. It may be sufficient that the loopback function involves using the circuit that is generally provided in the converting unit. If there is no circuit of the loopback function, however, it may be sufficient to incorporate a circuit including a diverging line and a loopback line for the loopback to the input interface DLIN from the output interface DLOUT when in the test mode. As a result, the packets sent to the converting unit SerDes0 of the CPU00 are transmitted to the converting unit SerDes0 of the CPU01. On the other hand, the packets sent to the converting units SerDes1-3 of the CPU00 are transmitted to the input interface DLIN1-3 of the CPU00.

The packets sent to the converting unit SerDes0 of the CPU01 are, similarly to when in the normal operation, transmitted to the MC 22 via the input interface DLIN0 and the buffer IBUF0 of the CPU01. The packet sent to the input interfaces DLIN1-3 of the CPU00 are transmitted to the registers R5-R7 of the CPU00 and then written to the buffers IBUF1-3 according to the flowchart in FIG. 11.

At this time, the packets written to the buffers IBUF1-3 are the packets originally transmitted to the CPU01 by the CPU00 and are therefore the packets that may not be received when viewed from a standpoint of the CPU00. If making an attempt to process these packets intact in the CPU00, there is a possibility that the operation is determined abnormal. Such being the case, according to TEST_MODE[1:3]=111, the AND gates A2-A7 on the ingress side of the MC 22 in FIG. 8 are disabled, and the processing is completed without transmitting the packets to the MC 22. Namely, unnecessary packets can be restrained from being input to the MC 22 owing to the operations of the AND gates A0-A7 according to the designation of TEST_MODE retained in the control information retaining unit 13. Note that the process of enabling and disabling the AND gates will be described later on in FIG. 11.

(Processing Flow)

An operation sequence of the hardware circuit when implementing the test illustrated in FIGS. 7 and 8 will hereinafter be described based on a flowchart. FIG. 10 is a diagram illustrating the processing sequence of the transmitting control unit SEND-CTRL0. Note that the process of each of other transmitting control units SEND-CTRL1-3 is the same as in FIG. 10. The following processing sequence of the transmitting control unit SEND-CTRL0 may be realized by the hardware circuit. Further, the processing sequence may also be realized by a sequencer of a programmable logic circuit such as FPGA (Field Programmable Gate Array). Moreover, the processing sequence may also be realized by the DSP executing the computer program.

In this process, the transmitting control unit SEND-CTRL0 determines whether or not the packet standing by for the transmission exists in the output buffer (OB1 etc) (S11). If the packet standing by for the transmission exists in the output buffer (OB1 etc), it is determined whether capacities of the retry buffer and the buffer IBUF of the transmitting destination are sufficient or not (S12). Herein, the capacity of the buffer IBUF of the transmitting destination is a capacity of the buffer IBUF0 of the CPU01 depicted in FIG. 9 in the case of transmitting the data to, e.g., the CPU01 from the CPU00. Herein, information on the capacity of the buffer IBUF of the transmitting destination is called a credit and transferred and received between the CPUs (between the CPU00-03, the CPU10-13 etc) connected via the unillustrated signal line.

If both of the determination results in S11 and S12 are “true” (YES), the transmitting control unit SEND-CTRL0 reads the packet into the register R0 and transmits the packet to the CPU01 via the output interface DLOUT0 and the converting unit SerDes0 (S13).

Whereas if any one of the determination results in S11 and S12 is “false” (NO), the transmitting control unit SEND-CTRL0 finishes processing without executing the process in S13.

FIG. 11 is a diagram illustrating the processing sequence of the receiving control unit RCV-CTRL0. Note that the same processing is applied to other receiving control units RCV-CTRL1-3. The following processing sequence of the receiving control unit RCV-CTRL0 may be realized by the hardware circuit. Further, the processing sequence may also be realized by a sequencer such as the programmable logic controller. Moreover, the processing sequence may also be realized by the DSP executing the computer program.

In this process, the receiving control unit RCV-CTRL0 determines whether the packet arrives at the register R4 or not (S21). It is to be noted that the registers R5-R7 become the determination target components in the receiving control units RCV-CTRL1-3.

When the packet reaches the register R4, the receiving control unit RCV-CTRL0 writes the packet received by R4 to the buffer IBUF0 (S22). Note that the buffers IBUF1-3 become the writing destinations in the receiving control units RCV-CTRL1-3.

Then, the receiving control unit RCV-CTRL0 determines whether the packet exists in the buffer IBUF0 or not (S23). Note that the buffers IBUF1-3 become the determination target components in the receiving control units RCV-CTRL1-3.

If the packet exists in the buffer IBUF0, the receiving control unit RCV-CTRL0 determines whether the test mode bit TEST_MODE[0] of the control information retaining unit 13 is “1” or not (S24). Note that TEST_MODE[1:3] becomes the determination target element in the receiving control units RCV-CTRL1-3.

When determining in S24 that the test mode bit TEST_MODE[0] is “1”, the receiving control unit RCV-CTRL0, by the data verifying unit PCC, extracts the packet and checks whether the packet is normal or not (S26). Whereas if the packet is not normal (N in S27), normal error processing is carried out in the information processing apparatus 1 (S28). In the error processing, for instance, the receiving control unit RCV-CTRL0 notifies the unillustrated computer etc for the system control of the error through a return value to the JTAG command of the CPU00. Moreover, if normal, the processing directly comes to an end. In this case, as depicted in FIG. 8, TEST_MODE[0]=1 is input to the AND gate A0 on the output side of the receiving control unit RCV-CTRL0 and the AND gate A1 on the path extending from the buffer IBUF0 to the arbiter AR via the data verifying unit PCC. Accordingly, the output of the receiving control unit RCV-CTRL0 is cut off by the AND gate A0. Further, the output from the buffer IBUF0 is cut off by the AND gate A1. Therefore, the packets of the buffer IBUF0 are, after being verified by the data verifying unit, input to neither the arbiter AR nor the MC 22.

Moreover, when determining in S24 that the test mode bit TEST_MODE[0] is “0”, TEST_MODE[0]=0 is input to the AND gates A0, A1 in FIG. 8. In this case, the receiving control unit RCV-CTRL0 is allowed to access the arbiter AR. Then, the receiving control unit RCV-CTRL0 requests the arbiter AR to input the data (a right of packet transmission). Subsequently, the receiving control unit RCV-CTRL0 determines whether the right of packet transmission is acquired in the arbiter AR or not (S25).

Then, if the right of packet transmission is acquired, the receiving control unit RCV-CTRL0 extracts the packet from the buffer IBUF0 according to the normal procedure. Subsequently, the receiving control unit RCV-CTRL0, by the data verifying unit PCC, checks whether the extracted packet is normal or not (S29). Subsequently, if the packet is normal (Y in S2A), the receiving control unit RCV-CTRL0 transmits the packet to the MC 22 via the arbiter AR (S2B). Whereas if the packet is not normal (N in S2A), normal error processing is executed in the information processing apparatus 1 (S28).

FIG. 12 illustrates bus selection logic of the bus selector S0. FIG. 12 depicts the logic, in a flowchart format, corresponding to the test mode TEST_MODE[0:3] of the logical circuit in the bus selector S0 of, e.g., the CPU00.

The bus selector S0 preferentially determines whether TEST_MODE[0]=0 is established or not (S31). Then, if TEST_MODE[0]=0 is established (Y in S31), the bus selector S0 selects the path extending from the register R0 (S32). This is the case of being connected to the peer CPU01 via the interfaces 0, i.e., the input interface DLIN0 and the output interface DLOUT0.

Whereas when determining in S31 that TEST_MODE[0]=0 is not established, the bus selector S0 determines next whether TEST_MODE[1]=0 is established or not (S33). Then, if TEST_MODE[1]=0 is established (Y in S33), the bus selector S0 selects the path extending from the register R1 (S34). This is the case of being connected to the peer CPU01 via the interfaces 1, i.e., the input interface DLIN1 and the output interface DLOUT1.

Further, when determining in S33 that TEST_MODE[1]=0 is not established, the bus selector S0 determines next whether TEST_MODE[2]=0 is established or not (S35). Then, if TEST_MODE[2]=0 is established (Y in S35), the bus selector S0 selects the path extending from the register R2 (S36). This is the case of being connected to the peer CPU02 via the interfaces 2, i.e., the input interface DLIN2 and the output interface DLOUT2.

Further, when determining in S35 that TEST_MODE[2]=0 is not established, the bus selector S0 selects the path extending from the register R3 (S37). This is the case of being connected to the peer CPU03 via the interfaces 3, i.e., the input interface DLIN3 and the output interface DLOUT3.

Note that the determination is made in the sequence of TEST_MODE[0]=0, TEST_MODE[1]=0, TEST_MODE[2]=0, TEST_MODE[3]=0 in FIG. 12. It may be, however, sufficient that the determination about TEST_MODE[0]=0 is prioritized in the selection logic of the bus selector S0, while the three determinations about TEST_MODE[1]=0, TEST_MODE[2]=0, TEST_MODE[3]=0 are allowed not to follow the sequence in FIG. 12.

FIG. 13 illustrates the bus selection logic of the bus selector S1. FIG. 13 illustrates the logic, in the flowchart format, corresponding to the test mode TEST_MODE[0:3] of the logical circuit in the bus selector S1 of, e.g., the CPU00. The logic of the bus selector S1 illustrated in FIG. 13 is substantially the same as the logic of the bus selector S0 in FIG. 12 except a point of prioritizing the determination as to whether TEST_MODE[1]=0 is established or not.

Namely, the bus selector S1 preferentially determines whether TEST_MODE[1]=0 is established or not (S41). Then, if TEST_MODE[1]=0 is established (Y in S41), the bus selector S1 selects the path extending from the register R1 (S42).

Whereas when determining in S41 that TEST_MODE[1]=0 is not established, the bus selector S1 determines next whether TEST_MODE[0]=0 is established or not (S43). Then, if TEST_MODE[0]=0 is established (Y in S43), the bus selector S1 selects the path extending from the register R0 (S44).

Further, when determining in S43 that TEST_MODE[0]=0 is not established, the bus selector S1 determines next whether TEST_MODE[2]=0 is established or not (S45). Then, if TEST_MODE[2]=0 is established (Y in S45), the bus selector S1 selects the path extending from the register R2 (S46). Still further, when determining in S45 that TEST_MODE[2]=0 is not established, the bus selector S1 selects the path extending from the register R3 (S47).

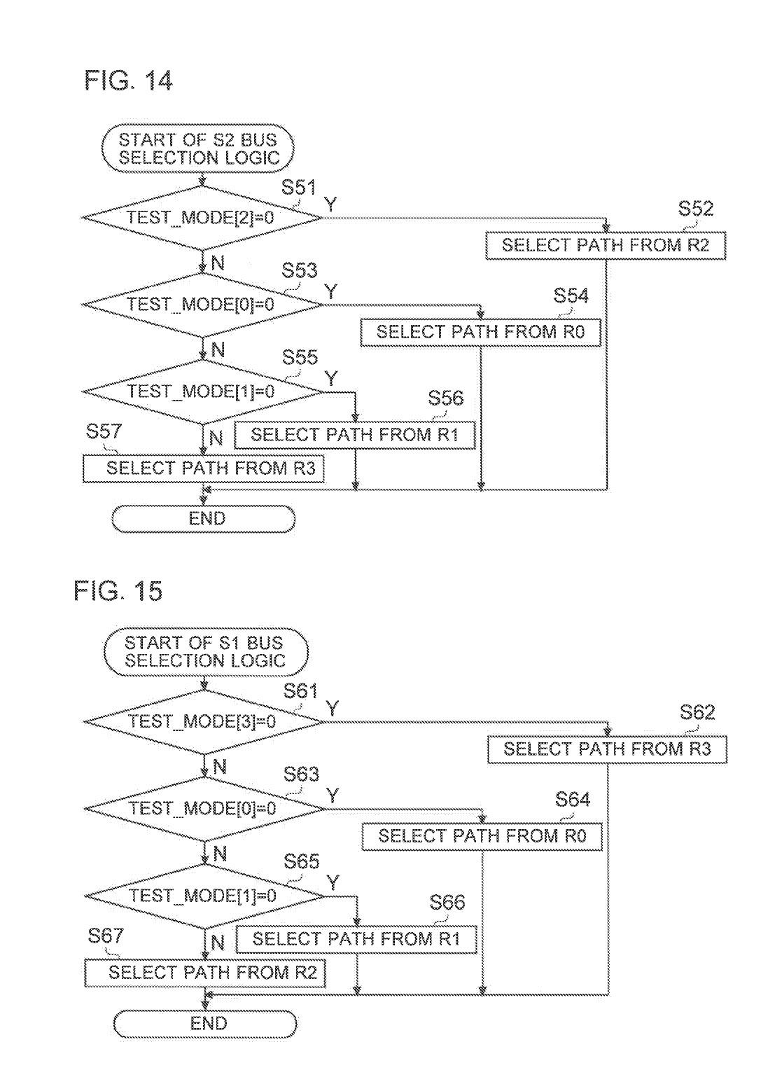

FIG. 14 illustrates the bus selection logic of the bus selector S2. FIG. 14 depicts the logic, in the flowchart format, corresponding to the test mode TEST_MODE[0:3] of the logical circuit in the bus selector S2 of, e.g., the CPU00. The logic of the bus selector S2 illustrated in FIG. 14 is substantially the same as the logic of the bus selector S0 in FIG. 12 except a point of prioritizing the determination as to whether TEST_MODE[2]=0 is established or not.

Namely, the bus selector S2 preferentially determines whether TEST_MODE[2]=0 is established or not (S51). Then, if TEST_MODE[2]=0 is established (Y in S51), the bus selector S2 selects the path extending from the register R2 (S52).

Whereas when determining in S51 that TEST_MODE[2]=0 is not established, the bus selector S2 determines next whether TEST_MODE[0]=0 is established or not (S53). Then, if TEST_MODE[0]=0 is established (Y in S53), the bus selector S2 selects the path extending from the register R0 (S54).

Further, when determining in S53 that TEST_MODE[0]=0 is not established, the bus selector S2 determines next whether TEST_MODE[1]=0 is established or not (S55). Then, if TEST_MODE[1]=0 is established (Y in S55), the bus selector S2 selects the path extending from the register R1 (S56). Still further, when determining in S55 that TEST_MODE[1]=0 is not established, the bus selector S2 selects the path extending from the register R3 (S57).

FIG. 15 illustrates the bus selection logic of the bus selector S3. FIG. 15 depicts the logic, in the flowchart format, corresponding to the test mode TEST_MODE[0:3] of the logical circuit in the bus selector S3 of, e.g., the CPU00. The logic of the bus selector S3 illustrated in FIG. 15 is substantially the same as the logic of the bus selector S0 in FIG. 12 except a point of prioritizing the determination as to whether TEST_MODE[3]=0 is established or not.

Namely, the bus selector S3 preferentially determines whether TEST_MODE[3]=0 is established or not (S61). Then, if TEST_MODE[3]=0 is established (Y in S61), the bus selector S3 selects the path extending from the register R3 (S62).

Whereas when determining in S61 that TEST_MODE[3]=0 is not established, the bus selector S3 determines next whether TEST_MODE[0]=0 is established or not (S63). Then, if TEST_MODE[0]=0 is established (Y in S63), the bus selector S3 selects the path extending from the register R0 (S64).

Further, when determining in S63 that TEST_MODE[0]=0 is not established, the bus selector S3 determines next whether TEST_MODE[1]=0 is established or not (S65). Then, if TEST_MODE[1]=0 is established (Y in S65), the bus selector S3 selects the path extending from the register R1 (S66). Still further, when determining in S65 that TEST_MODE[1]=0 is not established, the bus selector S3 selects the path extending from the register R2 (S67).

(Operation Sequence)

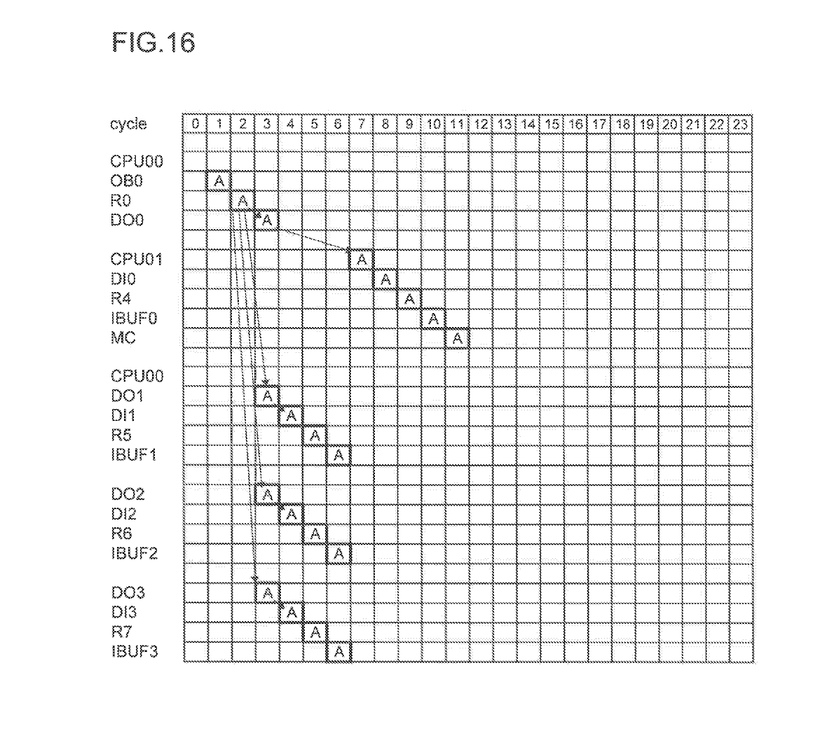

FIG. 16 illustrates a time chart when transmitting the packet to the CPU01 from the CPU00 when setting TEST_MODE[0:3]=0111. Herein, the axis of abscissa in FIG. 16 indicates a cycle of the clock for driving, e.g., the CPU00-CPU03 etc. Further, the axis of ordinate in FIG. 16 indicates the output buffer OB0, the register R0, the retry buffer DO0 of the CPU00, and the input buffer DI0, the register R4, the buffer IBUF0, the MC 22, etc of the CPU01. Moreover, in FIG. 16, the components of the interfaces 1-3 of the CPU00 are enumerated. That is, the retry buffers DO1-3, the input buffers DI1-3, the registers R5-7 and the buffers IBUF1-3 of the CPU00 are indicated along the axis of ordinate in FIG. 16.

FIG. 16 illustrates that a packet A is transmitted to the retry buffer DO0 from the register R0 and copied to the retry buffers DO1, DO2, DO3 at the third cycle. At the fourth cycle, the copied packets existing in the retry buffers DO1, DO2, DO3 are turned back and thus forwarded to the input buffers DI1, DI2, D13 of the CPU00. The packets forwarded to the CPU01 are transmitted to the MC at the eleventh cycle, however, the packets turned back at the CPU00 complete being processed at the sixth cycle.

The validity of the turned-back packet and the validity of the operation of each function block are checked by (1) the CRC checker possessed by the input interfaces DLIN1-3 and by (2) the parity checker, the protocol checker, etc possessed by the buffers IBUF1-3 and the receiving control units RCV-CTRL0-3. These checkers operate for checking, even when in the normal operation, whether the hardware gets into failure or not. As a result, it is feasible to test simultaneously the interface circuit units of the CPU02, the CPU03, the XB0, XB1, etc even in the state of implementing the test by connecting the CPU00 and the CPU01 together. The test may be conducted by use of a test program for executing the data transfer between, e.g., the CPU00 and the CPU01.

<Effects>

Owing to the architecture described above, the operation check for the interfaces other than the interfaces to be used actually can be done even with the simple configuration in the configurations that can be taken by the information processing apparatus 1. For example, as illustrated in FIG. 9, the CPU00 and the CPU01 are connected via the interfaces 0, and, even when not yet establishing the connections of the interfaces via which the CPU00 connects with the CPU02 and the CPU03, the unconnected interfaces can be tested by using the signals transmitted to the CPU01 from the CPU00.

For example, as depicted in FIG. 8, it may be sufficient that the bus selectors S1-S3 copy the packets of the register R0 that are transmitted to the CPU01 from the CPU00, and the copied packets are turned back at the converting units SerDes1-3 and input to the input interface DLIN1-3. It may be sufficient that the turned-back signals are, e.g., CRC-checked in the input interfaces DLIN1-3. Further, it may also be sufficient that the receiving control units RCV-CTRL1-3 perform the parity check, the protocol check, etc of the turned-back signals by use of the data verifying units PCC. Moreover, it may be sufficient that the turned-back signals are disabled from being input to the arbiter AR etc to avoid the contradiction within the CPU00 where the signals are turned back.

Furthermore, in the second working example described above, the test mode bits TEST_MODE[0:3] of the control information retaining unit 13 designate the selection of the bus selectors S0-3, the loopback or non-loopback at the converting units SerDes0-3 and the enable/disable setting for the input to the arbiter AR. Accordingly, an operator etc, who performs testing the information processing apparatus 1, can simply implement the test by setting the control information in the test mode bits TEST_MODE[0:3] of the control information retaining unit 13 by use of, e.g., the JTAG commands etc from on the computer for system management that controls the information processing apparatus 1. Further, it may be sufficient that the operator reads and checks the test result by the JTAG commands etc.

The packets transmitted by the information processing apparatus 1 described in the second working example become the packets used for the actual communications between the CPUs when running the test program on the CPUs. Moreover, the packet issuance timing is influenced by a variety of hardware statuses such as the status of the cache, “BUSY” of the buffer (an event of “buffer busy waits”) and the conflict of resources on the CPU. The test can be therefore implemented at the timing and with the data pattern, which are close to the environment of the actual operation.

The architecture described above is provided in the respective CPUs included in the information processing apparatus 1, such as the CPU00-03 and other CPUs connected via the crossbar switches XB0 illustrated in FIG. 7 or the CPU10-13 connected via the crossbar switches XB1 etc demonstrated in the configuration of FIG. 1. Accordingly, the information processing apparatus 1, the CPU00 serving as the transmitting device and another CPU serving as the receiving device can be subjected to the implementation of the test in a way that activates as many portions as possible with not the maximum configuration but the prospective extensible configuration or the configuration close to the single component unit to the greatest possible degree.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a transmitting device; and
a first receiving device to be connected to the transmitting device,
the transmitting device including:
a first input unit to input data;
a second input unit to input data;
a first information processing unit to output data based on information processing of the data input by the first input unit or the data input by the second input unit;
a first retaining unit to retain the data output by the first information processing unit;
a second retaining unit to retain the data output by the first information processing unit;
a control information retaining unit to retain control information;
a first selection unit to select, based on the control information retained in the control information retaining unit, any one of the data retained in the first retaining unit and the data retained in the second retaining unit; and
a first output unit to turn the data selected by the first selection unit back to the first input unit on the basis of the control information retained in the control information retaining unit.

2. The information processing apparatus according to claim 1, wherein the transmitting device further includes:
a second selection unit to select, based on the control information retained in the control information retaining unit, any one of the data retained in the first retaining unit and the data retained in the second retaining unit; and
a second output unit to output the data selected by the second selection unit to a second receiving device,
and the second receiving device includes:
a second information processing unit to perform information processing about the data input from the second output unit of the transmitting device.

3. The information processing apparatus according to claim 1, wherein in the transmitting device, the first selection unit selects the data retained in the second retaining unit on the basis of the control information retained in the control information retaining unit,
the second selection unit selects the data retained in the second retaining unit on the basis of the control information retained in the control information retaining unit, and
the first output unit includes a loopback portion to turn back the data selected by the first selection unit to the first input unit on the basis of the control information retained in the control information retaining unit.

4. The information processing apparatus according to claim 1, wherein in the transmitting device, the second output unit turns back the data selected by the second selection unit to the second input unit on the basis of the control information retained in the control information retaining unit.

5. The information processing apparatus according to claim 1, the transmitting device further including:
an invalidating unit to invalidate the data turned back from the first output unit of the transmitting device on the basis of the control information retained in the control information retaining unit.

6. A transmitting device to be connected to a first receiving device, the transmitting device being possessed by an information processing apparatus, comprising:
a first input unit to input data;
a second input unit to input data;
a first information processing unit to output data based on information processing of the data input by the first input unit or the data input by the second input unit;
a first retaining unit to retain the data output by the first information processing unit;
a second retaining unit to retain the data output by the first information processing unit;
a control information retaining unit to retain control information;
a first selection unit to select, based on the control information retained in the control information retaining unit, any one of the data retained in the first retaining unit and the data retained in the second retaining unit; and
a first output unit to turn the data selected by the first selection unit back to the first input unit on the basis of the control information retained in the control information retaining unit.

7. The transmitting device according to claim 6, further comprising:
a second selection unit to select, based on the control information retained in the control information retaining unit, any one of the data retained in the first retaining unit and the data retained in the second retaining unit; and
a second output unit to output the data selected by the second selection unit to a second receiving device.

8. The transmitting device according to claim 6, wherein the first selection unit selects the data retained in the second retaining unit on the basis of the control information retained in the control information retaining unit,
the second selection unit selects the data retained in the second retaining unit on the basis of the control information retained in the control information retaining unit, and
the first output unit includes a loopback portion to turn back the data selected by the first selection unit to the first input unit on the basis of the control information retained in the control information retaining unit.

9. The transmitting device according to claim 6, wherein the second output unit turns back the data selected by the second selection unit to the second input unit on the basis of the control information retained in the control information retaining unit.

10. The transmitting device according to claim 6, further comprising an invalidating unit to invalidate the data turned back from the first output unit on the basis of the control information retained in the control information retaining unit.

11. A control method of an information processing apparatus including:
a transmitting device; and
a first receiving device to be connected to the transmitting device,
the method comprising:
inputting data by a first input unit of the transmitting device;
inputting data by a second input unit of the transmitting device;
outputting by a first information processing unit of the transmitting device, data based on information processing of the data input by the first input unit or the data input by the second input unit;
retaining in a first retaining unit of the transmitting device, the data output by the first information processing unit;
retaining in a second retaining unit of the transmitting device, the data output by the first information processing unit;
retaining control information in a control information retaining unit;
selecting by a first selection unit of the transmitting device, based on the control information retained in the control information retaining unit, any one of the data retained in the first retaining unit and the data retained in the second retaining unit; and
turning back by a first output unit of the transmitting device, based on the control information retained in the control information retaining unit, the data selected by the first selection unit to the first input unit.

12. The control method of the information processing apparatus according to claim 11, further comprising:
selecting by a second selection unit of the transmitting device, based on the control information retained in the control information retaining unit, any one of the data retained in the first retaining unit and the data retained in the second retaining unit; and
outputting by a second output unit of the transmitting device, the data selected by the second selection unit to a second receiving device on the basis of the control information retained in the control information retaining unit.

13. The control method of the information processing apparatus according to claim 11, wherein the first selection unit selects the data retained in the second retaining unit on the basis of the control information retained in the control information retaining unit,
the second selection unit selects the data retained in the second retaining unit on the basis of the control information retained in the control information retaining unit, and
the first output unit turns back the data selected by the first selection unit to the first input unit on the basis of the control information retained in the control information retaining unit.

14. The control method of the information processing apparatus according to claim 11, wherein the second output unit turns back the data selected by the second selection unit to the second input unit on the basis of the control information retained in the control information retaining unit.

15. The control method of the information processing apparatus according to claim 11, further comprising invalidating the data turned back from the first output unit of the transmitting device on the basis of the control information retained in the control information retaining unit.

16. A transmitting device to be connected to a receiving device, comprising:
a plurality of input units;
an information processing unit to output data based on information processing of data input by any one of the input units;
a plurality of output units to transmit the data output from the information processing unit to a receiving device, each of the output units including a loop back unit to turn back the data from the information processing unit to any one of the input units on the basis of a control information.

17. A control method of a transmitting device including a plurality of input units and a plurality of output units, comprising:
outputting data based on information processing of the data input by any one of the input units;
turning back the data from an information processing unit to any one of the input units on the basis of a control information, in each of the output units to transmit the data output from the information processing unit to a receiving device.
